(19) United States
(12) Patent Application Publication
(10) Pub. No.: US 2004/0073504 A1
(43) Pub. Date: Apr. 15, 2004

(54) Systems and methods for increasing recovery rates on delinquent financial accounts

(75) Inventors: Evan Bryman, Arlington, VA (US); James A. Haworth, Boise, ID (US); Femi Allen, Washington, DC (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/267,831

(22) Filed: Oct. 10, 2002

(51) Int. Cl. G06F 17/60

(52) U.S. Cl. 705/36

(57) ABSTRACT

Systems and methods consistent with the present invention managing delinquent financial accounts to allow the account issuer to increase recovery rates for these accounts. In such systems and methods, debt associated with the delinquent financial account is charged-off. The financial account is, however, kept open and the charged-off debt is then restructured to reduce a required payment amount for the account. Then, if the customer does not make the required payments, the account is closed.

### BACKGROUND OF THE INVENTION

1. Field of the Invention

Systems and methods consistent with the present invention relate to increasing recovery rates on delinquent financial accounts and, more particularly, to systems and methods for recovering debt from customers of such accounts.

2. Description of the Related Art

Credit issuing businesses and other financial institutions of all sizes and types sometimes have problems with customers who are delinquent in paying off debt. Non-payment of debt, such as credit card debt, may cost these businesses millions of dollars a year in revenue. Accordingly, most financial institutions will not wait indefinitely for delinquent customers to pay their debt and, instead, attempt to recover that debt soon after the account becomes delinquent.

To recover debt, creditors usually employ a variety of tactics to collect from delinquent customers. Such tactics may begin with some type of reminder, such as a letter or telephone call. Initial efforts are usually non-confrontational in case there has been a misunderstanding, such as when the customer erroneously believes the debt had been previously paid or when the credit issuer has not yet received the payment already sent by the customer. A credit issuer will likely receive any late payment from a customer in response to such a reminder. For other customers, however, the reminders will not suffice and the debts will remain unpaid. Accordingly, creditors are often forced to impose more vigorous attempts to collect the outstanding debt from the customer, sometimes resorting to litigation in the more extreme cases.

An account that remains delinquent for a lengthy, period of time is designated as “charged-off”. When an account is “charged-off,” the credit issuer will close the account and “write it off” (i.e., the account is considered a loss, rather than a receivable asset). As such, charged-off accounts represent a negative industry metric since these accounts essentially represent a measure of assets that have turned into liabilities or losses. Since creditors may continue to try collecting on charged-off accounts, a more accurate metric of the loss associated with these accounts is the “Net Credit Loss” metric. Net Credit Loss represents the amount of charge-offs minus the amount of recovered debt. Creditors, therefore, try to increase their debt recovery rates on charged-off accounts.

A customer may have difficulty making payments on a severely delinquent account due to the nature of financial accounts. Financial accounts typically require a monthly minimum payment to be made by the customer. If the customer fails to make a payment then the account becomes delinquent. When the account is one month delinquent, then the customer will typically be required to make a payment of at least two monthly minimum payments. If the customer again fails to make any, then the account is two months delinquent and the minimum amount owed is three monthly minimum payments. Thus a customer who could not afford to pay one monthly minimum payment, is less able to pay in following months when the minimum payment is multiplied. This typically results in an account becoming severely delinquent because the creditor has little flexibility to reduce the amount that the customer has to pay to keep the account open.

One possible reason for a customer's non-willingness to pay after an account has been charged-off is that repayment plans are often unattractive to the customer. For example, the creditor may not offer any incentive for making repayments, other than repairing the customer's credit history or preventing further phone calls or other collection attempts. This is often insufficient to prod customers into repayment. Other repayment plans may offer the customer an adequate incentive, but may require a substantial portion of repayment before the incentive becomes available. For example, a creditor may offer a repayment incentive to customers, but only upon repayment of the full debt amount. Satisfaction of the requirement may seem so unlikely or so distant to the customer that the incentive is not realistic. Further, none of these repayment plans prod customers into repayment by reducing the minimum amount due. Further yet, none of the repayment plans allow customers to kept their accounts open after they have been charged-off.

One method creditors use to entice customers to repay debt is the use of a reaffirmation financial account. The creditor closes the original account and makes an offer to the customer to “reaffirm” or acknowledges that he or she owes the outstanding debt of that account. If the customer accepts the offer, the creditor may then issue the customer a new credit card and transfer the balance of the pre-existing debt to the credit card. By making payments on the owed debt, a line of credit to the customer may become available or increase. This is attractive to the customer, because the customer receives an incentive (the line of credit) for paying the pre-existing debt. This is also attractive to the creditor because the creditor receives payments on the charged-off account.

However, this method of offering reaffirmation accounts is not ideal for customers as they must go through a credit application process. Further, the customers typically view their former creditor with mistrust since that creditor closed their former account. This method is also not ideal for the credit issuer since typically only a low number of customers apply for a reaffirmation card, and many of those customers who do not receive a reaffirmation card, do not make any payments on their delinquent debt.

Thus, there is a need for a system and method enabling a creditor to increase recovery rates of delinquent accounts. Moreover, there is a need for such a system and method that creates an incentive for the delinquent customer to pay off their debt.

### SUMMARY OF THE INVENTION

Systems and methods consistent with the present invention allow a financial institution to increase recovery rates on delinquent accounts by providing the customer with a greater incentive to pay off the debt.

Specifically, systems and methods consistent with the present invention manage a delinquent financial account of a customer. According to such systems and methods, debt associated with the delinquent financial account is charged-off. The financial account is, however, kept open and the charged-off debt is then restructured to reduce a required payment amount for the account from the customer. If the customer does not make the required payments, the account is closed.

Both the foregoing general description and the following detailed description are exemplary and are intended to provide further explanation of the embodiments of the invention as claimed.

### BRIEF DESCRIPTION OF THE DRAWINGS

The accompanying drawings, which are incorporated in and constitute a part of this specification, illustrate various embodiments of the present invention, and, together with the description, serve to explain exemplary features of the invention. In the drawings:

FIG. 1 generally illustrates an exemplary method, consistent with the present invention, for managing delinquent financial accounts;

FIG. 2 is an exemplary block diagram of a system environment, consistent with the present invention, for managing delinquent financial accounts;

FIG. 3 is an exemplary flow chart of a method, consistent with the present invention, for managing delinquent financial accounts; and

FIG. 4 is an exemplary flow chart of a method, consistent with the present invention, for processing payments from a customer after a financial institution has charged-off the customer's financial account.

### DETAILED DESCRIPTION

Systems and methods consistent with the present invention enable a financial institution to increase recovery rates of delinquent financial accounts. To this end, embodiments of the invention include an account processing platform that may restructure owed debt to thereby increase the customer's willingness to repay that debt. For instance, when an account reaches a severe point of delinquency (e.g., a predetermined or regulated amount of time has passed without a sufficient payment from the customer), the account processing platform may charge-off the loan, keep the account open, and restructure the account debt terms. The restructured debt terms may include a lower monthly minimum payment and/or a lower interest rate applied to the debt. The restructured debt terms may also allow the customer to receive additional credit extensions in exchange for payments made to the already existing debt. By keeping the account open with more attractive repayment terms, the customer will have incentives to repay the debt and a better chance at doing so.

When the account processing platform restructures the debt, that debt will, as is the normal industry practice, be treated as a charged-off debt on the accounting books of the financial institution that issued the account. According to embodiments of the invention, if the customer fails to meet the new payment terms of the restructured debt, the processing platform will then close the account. Otherwise, by repaying the original debt under the new payment terms, the customer may receive the benefits from the use of the credit card. In this way, systems and methods consistent with the present invention increase a financial institution's recovery rates by restructuring debt to provide a greater incentive for a delinquent customer to make payments.

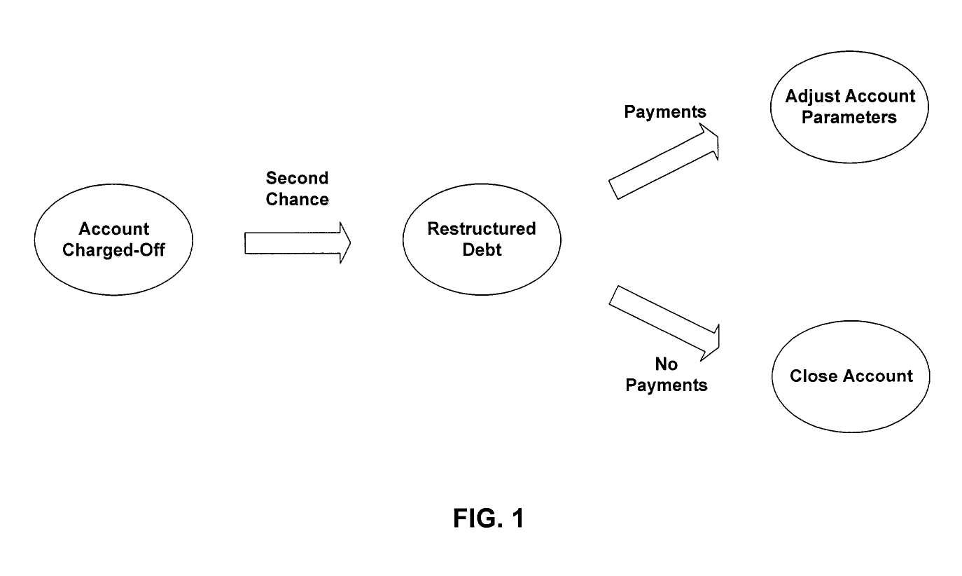

FIG. 1 is an exemplary diagram of a method for managing delinquent financial accounts, consistent with the present invention. In the following description, an account holder and the holder's account are generally referred to as “customer” and a “customer's account.” These designations are used solely for purposes of illustration and should not be interpreted as any form of limitation. As shown in FIG. 1, customers severely delinquent in paying a loan or outstanding balance associated with their financial accounts are given a second chance to pay off their debt. The time at which a customer is offered this second chance may be when the financial institution who issued the account would charge-off that account.

As used herein, the term “charge-off” refers to when a financial institution allocates a particular loan as a loss, rather than as a receivable asset. For example, the charge-off point may be between 120 and 180 days of delinquency, although other time periods may be used. Further, one of ordinary skill in the art will understand that the financial institution may give this second chance at a time period other than at the charge-off point.

When the customer receives the second chance, the customer is notified that even though the account has been charged-off, the account is still open and that its debt has been restructured. As used herein, an account is open when the account agreement still exists between the customer and the financial institution that issued the account. An account may then remain open even though the customer may, for example, receive a new plastic card with a new account number as long as the account agreement still applies to the customer. The customer therefore still has a valid, open account with the issuer.

Consistent with embodiments of the invention, the restructuring of the debt may include restructuring the credit card terms to resemble a “reaffirmation” credit card. Issuing a new plastic card to the customer may also strengthen the message that the customer is being given a second chance. In addition, the debt restructuring may also include at least one of the following: a lower required payment amount, a lower interest rate applied to any outstanding debt, and a credit limit increase in exchange for any new payments. Finally, when the customer is notified of the restructured debt, the customer may also be told that if still no payments are made to the account, then the account issuer will close the account.

The restructured debt terms thus provide the customer with a stronger incentive to pay off the debt. Consider the case when a customer owes a monthly minimum payment of $100 on a total balance of $1,000. If the customer misses the payment, the loan becomes delinquent and the customer will then owe a minimum of two monthly payments (e.g., $200) at the next payment cycle toward the outstanding debt. Another missed payment will then bring the total minimum amount due to $300. This cycle often makes it difficult for a consumer to bring his or her account out of delinquency. The same applies when the monthly minimum payment is increased to reflect overlimit purchases made by the customer. During the above debt restructuring at the charge-off point, the customer's minimum payment may be reduced to a lower minimum payment amount (e.g., $100). By so lowering the minimum payment amount due, systems consistent with the present invention provide an incentive to the customer to pay the debt.

Systems consistent with the present invention may also selectively identify customer accounts for debt restructuring prior to the passing of a standard delinquency period that the financial institution may typically use to charge-off that account. For example, the financial institution may identify customers who may be unable to meet the current payment terms of their delinquent account, even though their respective accounts have yet to be charged-off. The financial institution may then offer those customers the option of restructuring their debt, as described above. For the debt that is then restructured, the financial institution would then charge-off that debt and notifying each such customer of the new payment terms that must be met in order to keep their account open. Further, those skilled in the art will appreciate that the original account could also be closed and a new account issued at the customer's request and associated with the restructured debt.

Once the customer is presented with the restructured debt terms, systems and methods consistent with the invention may then track payments made by the customer to determine whether to adjust any account terms or parameters. When payments are received, for example, a credit limit associated with the account may be increased. In some cases, credit limit increases may depend upon the amount of the payment (e.g., the increase is a set amount smaller than that of the payment). In other cases, the credit increase may be a set amount whenever the customer makes a sufficient payment (e.g., a $50 increase for every payment of $100 or more). One of ordinary skill in the art, however, will understand that other types of credit limit increases may be used that reward payments made by the customer. Finally, if the customer does not make any payments to the restructured account, then the customer's account is closed.

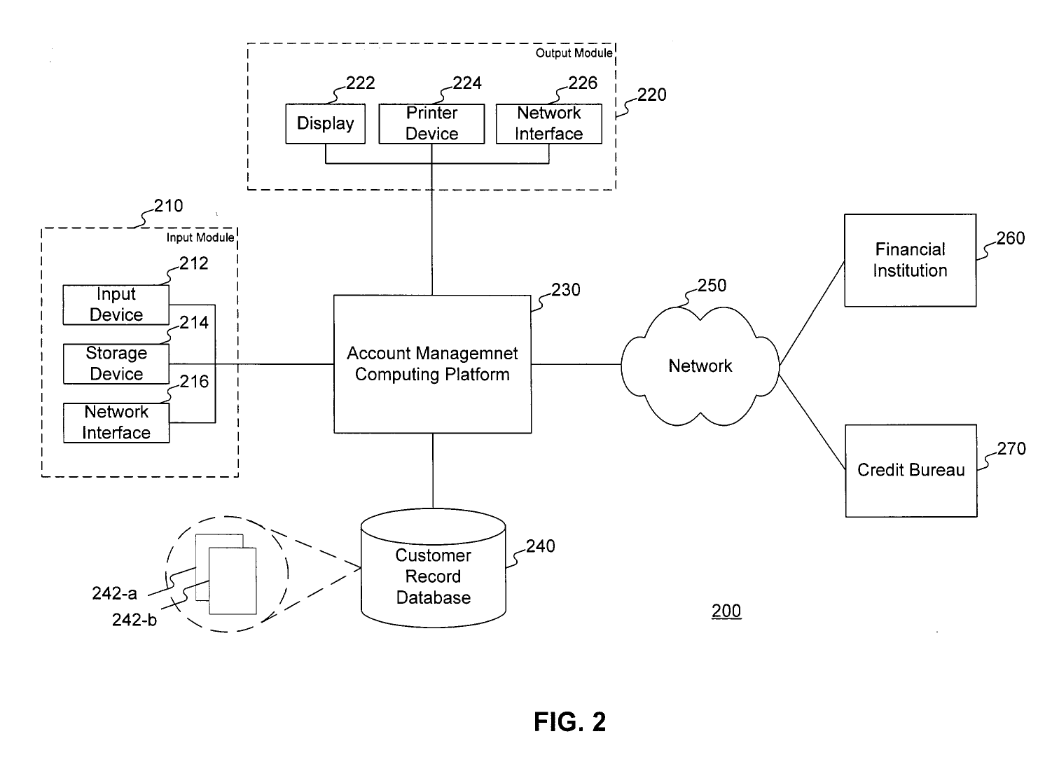

By way of a non-limiting example, FIG. 2 illustrates an account management system environment 200 for implementing embodiments consistent with the present invention. As illustrated in the block diagram of FIG. 2, system 200 includes an input module 210, an output module 220, a computing platform 230, and a customer record database 240. A network 250 may also be provided to facilitate communication with a financial institution 260 and a credit reporting bureau (CRB) 270. While the various components of system 200 may be owned and/or operated by a credit account issuer (e.g., financial institution 260), these components of course can be owned and/or operated by any number of entities for the benefit of the credit issuer and account holders.

Input module 210 may be implemented using a wide variety of devices to receive and/or provide the account data as input to computing platform 230. As illustrated in FIG. 2, input module 210 may include an input device 212, a storage device 214, and/or a network interface 216. Input device 212 may comprise a keyboard, a mouse, a disk drive or any other suitable input device for providing customer account data to computing platform 230. Storage device 214 may include a disk drive, optical drive, CD-ROM, or any other memory device for storing information. Input module 210 may also include network interface 216, as illustrated in FIG. 2, to receive data over a network (such as a LAN, WAN, intranet or the Internet) and to provide the same as input to computing platform 230. Input module 210 may be used to enter or obtain information about the customer or the customer's account, such as customer identification information, account transaction information, the outstanding debt, and/or payments made by the customer to the account. Input module 210 forwards the received information to computing platform for processing and/or storage in customer record database 240. Washington, DC 20005

As shown in FIG. 2, output module 220 may include a display 222, a printer device 224, and/or a network interface 226 for receiving the results provided as output from computing platform 230. The output from computing platform 230 may be displayed or viewed through display 222 (such as a CRT or LCD) and printer device 224. If needed, network interface 226 may also be provided to facilitate the communication of the results from computing platform 230 over a network (such as a LAN, WAN, intranet or the Internet) to remote or distant locations for further analysis or viewing. In either case, the output from output module 220 can be used to generate, for example, notifications to the customer about restructuring of the debt or about adjustments to account terms or parameters based on any received payments. The output from output module 210 can also be used for other purposes, such as internal reports or monitoring. Output module 230 may output processed account information to the customer, to financial institution 260 for use internally or for assisting the customer, and/or to CRB 270 for updating a customer's credit history.

Computing platform 230 provides the necessary functionality and computing capabilities for managing a customer's financial account. For instance, computing platform 230 may restructure the delinquent debt and process the outstanding debt and payment information received from input module 210. Computing platform 230 may also provide account information to output module 220. Additionally, computing platform 230 may access information in customer record database 240 to determine customer credit history information. Computing platform 230 may also receive the above customer or customer account information from financial institution 260, who may be the account issuer.

Computing platform 230 may comprise any personal computer, workstation, or mainframe computer for performing various functions and operations consistent with embodiments of the invention. Computing platform 230 may be implemented, for example, by a general purpose computer selectively activated or reconfigured by a computer program stored in a computer, or may be a specially constructed computing platform for carrying out the features and operations of the present invention. Computing platform 230 may also be implemented or provided with a wide variety of components or subsystems including, for example, one or more of the following: a central processing unit, a co-processor, memory, registers, and other data processing devices and subsystems.

Computing platform 230 may communicate or transfer customer and credit data to and from input module 210 and output module 220 through the use of direct connections or other types of communication links, as illustrated in FIG. 2. For instance, computing platform 230 may communicate with modules 210, 220 through the use of a network architecture similar to that of network 250. Platform 230 may output the results of analyzed data to output module 220, which prints or displays the results, or outputs it to other system devices, such as client record database 240.

Customer record database 240 stores customer account records 242. Each customer account record 242 may include a debt record 242-a and a payment history account record 242-b, as well as other account information concerning the customer and the financial account. Debt account record 242-a may store information concerning debt of the customer, such as information about the original debt amount associated with the financial account. Payment history record 242-b may store information about payments made by the customer. The payment information may include, for example, the amount of each payment made, the date the payment was made, and the date the payment was due. Database 240 may be any persistent storage device for storing client records.

Network 250 may comprise, alone or in any suitable combination, a telephony-based network (such as a PBX or POTS), a local area network (LAN), a wide area network (WAN), a dedicated intranet, and/or the Internet. Further, network 250 may comprise any suitable combination of wired and/or wireless components and systems. By using dedicated communication links or a shared network architecture, computing platform 230 may be located in the same location or at a geographically distant location from modules 210, 220, financial institution 260, and/or credit reporting bureau 270. Credit reporting bureau (CRB) 270 may be any credit reporting entity, such as one or more of the major credit bureaus, including TRW/Experian, Equifax, and TransUnion.

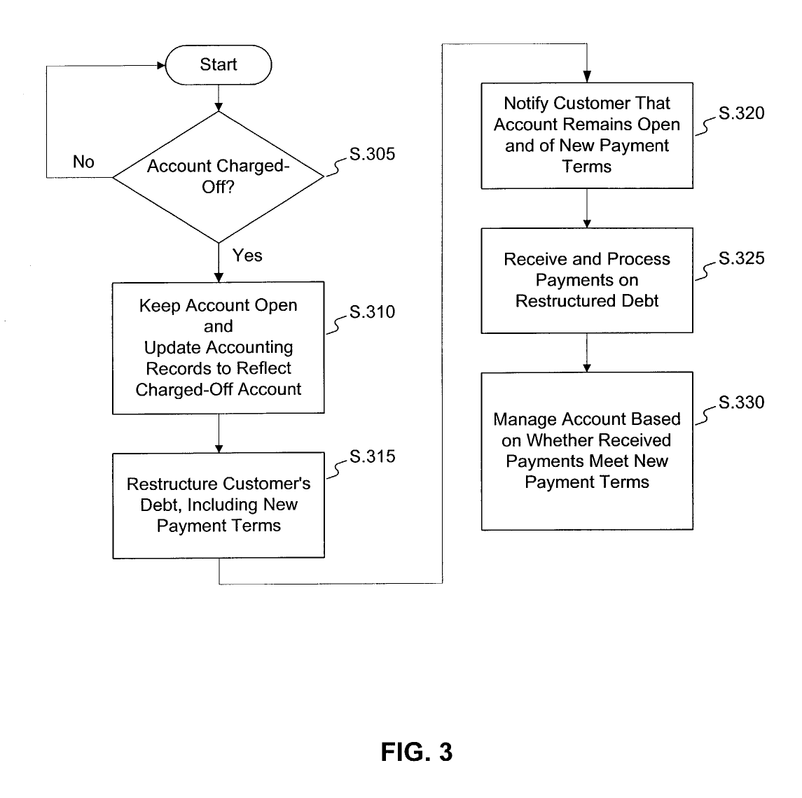

In accordance with the principles of the present invention, an exemplary process for managing delinquent financial accounts will now be described with reference to FIG. 3. Although the process of FIG. 3 is described with respect to processing a single financial account, platform 230 may apply the process in whole or in part to any number of financial accounts. As shown in FIG. 3, the account management process begins when computing platform 230 receives customer account information indicating that the financial account has reached the charge-off point (step 305). As discussed above, the “charge-off” point refers to when financial institution 260 allocates the account as a loss, rather than as a receivable asset. If the account has not been charged-off (step 305; No), then platform 230 processes the financial account according to the normal procedures for that account as understood by those of ordinary skill in the art.

Platform 230 may obtain the information indicating whether the account was charged-off from customer account records 242 stored in database 240 or from input module 210. Further, platform 230 may determine that a delinquent account should be charged-off when, for example, financial institution 260 has not received sufficient payments from the customer during a predetermined time period, such as no payments within the last 180 days. However, as described above, financial institution may use any delinquency time period to determine when the charge-off an account, including the use of different time periods for different accounts.

If the account has been charged-off (step 305; Yes), then platform 230 keeps the account open and updates the internal accounting records of financial institution 260 to reflect that the loan has been charged-off (step 310). As described above, the account may remain open even though the loan has been charged-off as long as the account agreement still applies to the account. The customer will thus still have an account associated with the original, delinquent debt.

Platform 230 may then restructure the delinquent debt to include new payment terms (step 315). For instance, the debt restructuring may also include at least one of the following new terms: a lower required payment amount, a lower interest rate applied to the delinquent debt, and allowing for a credit limit increase in exchange for any new payments. These new payment terms may be a part of the original account or part of a new account to which the delinquent debt is transferred. In one embodiment consistent with the present invention, the debt may be transferred to a “reaffirmation” account allowing for credit limit increases in exchange for customer payments.

In determining the new payment terms, platform 230 may consider payment amounts that the customer is more likely to make to the account. Often, when a customer has defaulted on a financial account, the outstanding payment due corresponds to an accumulated number of monthly minimum payments. For instance, if the customer's monthly minimum payment was $30 over the last six months in which the customer made no payments, then the customer's minimum payment due at the end of that six months would be $180. Since the customer was unable to pay the first $30 minimum payment due, the customer is then unlikely to pay the later $180. Accordingly, platform 230 adjusts the payment terms to reflect an amount due that the customer is more likely to pay. In one embodiment consistent with the present invention, the delinquent debt is restructured such that the minimum payment now due is lower (e.g., $30) and the interest rate applied to the delinquent debt may also be lower.

Platform 230 may then notify the customer that financial institution 260 has kept the account open subject to the new payment terms (step 320). To notify the customer, platform 230 may forward a letter or an e-mail, or initiate a telephone call to the customer, via output module 220. The forwarded notification would describe to the customer that the account is still open and that the customer has a second opportunity to pay the outstanding balance subject to the new payment terms that were determined above as part of step 315.

Afterwards, input module 210 may receive payment information on the customer's payments to the account for processing by platform 230 (step 325).

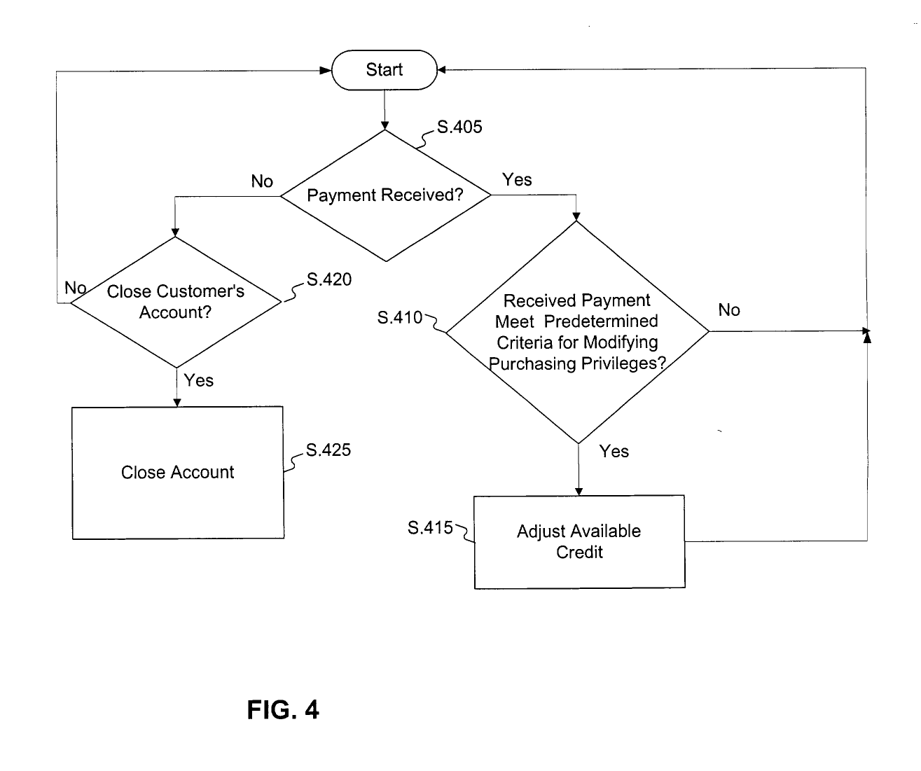

In performing such processing, platform 230 may analyze the received payments to determine whether they comply with the new payment terms previously determined by platform 230 and notified to the customer as part of processing steps 315 and 320 (step 330). Finally, platform 230 may update the customer's credit report with CRB 270. The processing of the received payment information included as part of steps 325 and 330 is described in further detail below with respect to FIG. 4.

FIG. 4 is an exemplary flow chart of a method, consistent with the present invention, for processing payments from a customer after a financial institution has charged-off the customer's financial account. As described above, computing platform 230 may be implemented to process payments from the customer after the customer receives notification that the account was restructured.

As shown in FIG. 4, computing platform 230 may first determine whether a required payment has been received from the customer (step 405). The required payment may correspond to the new minimum amount due under the restructured account terms.

If the customer did make a payment (step 405; Yes), then platform determines whether the received payment meets predetermined payment criteria for modifying the purchasing privileges of the restructured account (step 410). If platform 230 determines that the received payment meets the predetermined criteria (step 410; Yes), then platform 230 may increase the available credit limit of the restructured account (step 415). In some cases, a credit limit increase may depend upon the amount of the payment (e.g., the increase is a set amount smaller than that of the payment). In other cases, a credit increase may be a set amount whenever the customer makes a sufficient payment (e.g., a $50 increase for every payment of $100 or more). One of ordinary skill in the art, however, will understand that other types of credit limit increases may be used that reward payments made by the customer. After making any adjustments to the amount of available credit, processing then returns to await for the next payment from the customer.

If the customer substantially or fully pays off the outstanding debt, then step 415 may, in one possible embodiment, include reinstating the account's original purchasing privileges and may also adjust the customer's account record 242 to reinstate any other original account terms. For instance, as described above, the original account may be restructured as part of processing step 315 so that restrictions are placed on the amount of available credit. Thus, when platform 230 receives a notification that the customer has fully or substantially paid off the original debt, platform 230 may increase the customer's available credit to a level based on |what it was before the account became delinquent. If any of the outstanding debt remains after payment was received (i.e., when the debt was substantially paid off, but not fully), then, if the restructured debt had been transferred to a new account (e.g., a reaffirmation account), the remaining debt may be transferred back to the original account and the new account may be closed. However, as noted above, platform 230 may increase the credit limit to an amount lower than the original credit limit, even though the customer has fully paid off the outstanding debt.

If the customer has not made a required payment (step 405; No), then platform 230 determines whether to close the customer's account (steps 420).

In embodiments consistent with the present invention, platform 230 closes the customer's account when a predetermined number of consecutive monthly payments are not received. As described above, the conditions for keeping the account open may be outlined in the notification sent to the customer (e.g., as part of processing step 320). In an exemplary embodiment, the account may be closed if the customer misses two consecutive monthly payments. However, other conditions for closing the account may be set by platform 230, such as three consecutively missed payments, any two missed payments prior to paying off the full debt, or just one missed payment. Other conditions for closing the account may include, for example, the customer carrying an over-limit balance or the customer bouncing a check. In any event, if the account closing conditions are satisfied, platform 230 will close the account. Further, when the debt was transferred to a new account (e.g., a reaffirmation account), platform 230 may first transfer the debt back to the original financial account and then close both the original account and the new account.

As described above, systems and methods consistent with embodiments of the present invention allow financial account issuers to increase recovery rates on delinquent accounts by providing an account structure creating more incentive for customers to pay their debt. Further, financial accounts that can be used with embodiments of the invention are not limited to credit card accounts. Examples of financial accounts that are applicable to the invention include, for instance, mortgages and loans of any and all types. Moreover, financial institutions managing a financial account consistent with the invention may, for example, be the original owner of the charged-off account or a purchaser of the charged-off account for the original issuer of that account.

The above-noted features and other aspects and principles of the present invention may be implemented in various systems or network environments to provide automated computational tools for managing account records and performing tests to determine if various criteria are met. Such environments and applications may be specifically constructed for performing various processes and operations of embodiments of the invention or they may include a general purpose computer or computing platform selectively activated or reconfigured by program code to provide the necessary functionality.

The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of embodiments of the invention. The media and program instructions may be those specially designed and constructed for the purposes of the invention, or they may be of the kind well-known and available to those having skill in the computer software arts. Examples of program instructions include both machine code, such as produced by a compiler, and files containing a high level code that can be executed by the computer using an interpreter.

It will be apparent to those skilled in the art that various modifications and variations can be made to the invention without departing from the scope or spirit of the invention as disclosed herein. Therefore, it is intended that the specification and examples be considered as exemplary only, with a true scope and spirit of embodiments of the invention being indicated by the following claims.

What is claimed is:

1. A method for managing a delinquent financial account of a customer, comprising:
charging-off the debt associated with the delinquent financial account;
keeping the delinquent financial account open;
restructuring the charged-off debt of the delinquent financial account to reduce a required payment amount for the account from the customer; and
closing the delinquent financial account when the reduced required payment amount is not received from the customer.

2. The method of claim 1, wherein restructuring the charged-off debt further includes:
reducing the required payment amount to an amount substantially equal to a minimum payment for one account cycle.

3. The method of claim 2, wherein the minimum payment for one account cycle is a monthly minimum payment amount.

4. The method of claim 1, wherein restructuring the charged-off debt further includes:
reducing an interest rate applied to the delinquent debt.

5. The method of claim 4, wherein the interest rate is reduced to a value substantially lower than the interest rate associated with the delinquent financial account prior to restructuring.

6. The method of claim 1, wherein restructuring the charged-off debt further includes:
providing an available line of credit associated with the restructured account when a payment amount received from the customer meets a predetermined payment threshold.

7. The method of claim 1, wherein restructuring the charged-off debt further includes:
providing an available line of credit associated with the restructured account after receiving the reduced required payment amount.

8. The method of claim 7, wherein providing the available line of credit further includes:
increasing the line of credit based on received payments from the customer.

9. The method of claim 1, further including: when the delinquent debt has been substantially paid, increasing a line of credit for the customer.

10. The method of claim 9, wherein the line of credit is increased to an amount offered prior to the debt becoming delinquent.

11. The method of claim 1, wherein charging-off the debt further includes:
determining that the customer is not likely to pay a minimum amount due to the delinquent financial account; and
charging-off the debt associated with the financial account based on the determination, such that the debt is charged-off prior to when such debt is normally charged-off.

12. A system for managing a delinquent financial account of a customer, comprising:
means for charging-off the debt associated with the delinquent financial account;
means for keeping the delinquent financial account open;
means for restructuring the charged-off debt of the delinquent financial account to reduce a required payment amount for the account from the customer; and
means for closing the delinquent financial account when the reduced required payment amount is not received from the customer.

13. The system of claim 12, wherein the means for restructuring the charged-off debt further includes: means for reducing the required payment amount to an amount substantially equal to a minimum payment for one account cycle.

14. The system of claim 13, wherein the minimum payment for one account cycle is a monthly minimum payment amount.

15. The system of claim 12, wherein the means for restructuring the charged-off debt further includes:
means for reducing an interest rate applied to the delinquent debt.

16. The system of claim 15, wherein the interest rate is reduced to a value substantially lower than the interest rate associated with the delinquent financial account prior to restructuring.

17. The system of claim 12, wherein the means for restructuring the charged-off debt further includes:
means for providing an available line of credit associated with the restructured account when a payment amount received from the customer meets a predetermined payment threshold.

18. The system of claim 12, wherein the means for restructuring the charged-off debt further includes:
means for providing an available line of credit associated with the restructured account after receiving the reduced required payment amount.

19. The system of claim 18, wherein the means for providing the available line of credit further includes:
means for increasing the line of credit based on received payments from the customer.

20. The system of claim 12, further including:
when the delinquent debt has been substantially paid, means for increasing a line of credit for the customer.

21. The system of claim 20, wherein the line of credit is increased to an amount offered prior to the debt becoming delinquent.

22. The system of claim 12, wherein the means for charging-off the debt further includes:
means for determining that the customer is not likely to pay a minimum amount due to the delinquent financial account; and
means for charging-off the debt associated with the financial account based on the determination, such that the debt is charged-off prior to when such debt is normally charged-off.
